(19) United States
(12) Patent Application Publication
(10) Pub. No.: US 2016/0029431 A1
(43) Pub. Date: Jan. 28, 2016

(54) METHOD OF DETERMINING EXPIRATION PERIOD OF TIMER, NETWORK NODE, BASE STATION, AND NON-TRANSITORY COMPUTER READABLE MEDIUM

(71) Applicant: NEC CORPORATION, Tokyo (JP)

(72) Inventors: Masayoshi SHIMIZU, Tokyo (JP); Takanori IWAI, Tokyo (JP)

(73) Assignee: NEC CORPORATION, Tokyo (JP)

(21) Appl. No.: 14/776,860

(22) PCT Filed: Jan. 22, 2014
(86) PCT No.: PCT/JP2014/000295

§ 371 Date: Sep. 15, 2015

(30) Foreign Application Priority Data
Apr. 10, 2013 (JP) 2013-081925

(51) Int. Cl. H04W 76/04; H04L 12/26

(52) U.S. Cl. CPC H04W 76/046; H04L 43/0882

(57) ABSTRACT

A network node (100 or 200) is configured to determine, based on a congestion degree of a radio access network (10), an expiration period of a timer (101) used to determine a transition from a CONNECTED state to an IDLE state of a mobile terminal (300) connected through the radio access network (10) to a mobile core network (20). It is thus possible, for example, to suppress a decrease in a connection success rate of mobile terminals to a network due to adjustments of an expiration period of a UE inactivity timer.

### TECHNICAL FIELD

The present application relates to a mobile communication system, and more specifically, to adjustment of a timer that measures duration of an inactive state during which a mobile terminal does not perform data communication.

### BACKGROUND ART

A multiple access mobile communication system enables a plurality of mobile terminals to perform wireless communication substantially simultaneously, by sharing radio resources including at least one of time, frequency, and transmission power among the plurality of mobile terminals. Typical examples of multiple access schemes include Time Division Multiple Access (TDMA), Frequency Division Multiple Access (FDMA), Code Division Multiple Access (CDMA), or Orthogonal Frequency Division Multiple Access (OFDMA) and any combination thereof. Unless otherwise explained, the term “mobile communication system” used in this specification refers to a multiple access mobile communication system.

The mobile communication system includes a mobile terminal and a network. The network includes a radio access network (RAN) and a mobile core network (MCN). The mobile terminal communicates with an external network (e.g., the Internet, a packet data network, or a private enterprise network) through the RAN and the MCN. The mobile communication system is, for example, a 3rd Generation Partnership Project (3GPP) Universal Mobile Telecommunications System (UMTS) or an Evolved Packet System (EPS). The RAN is, for example, a Universal Terrestrial Radio Access Network (UTRAN) or an Evolved UTRAN (E-UTRAN). The MCN is, for example, a General Packet Radio Service (GPRS) packet core or an Evolved Packet Core (EPC).

Patent literature 1 discloses measuring, by a mobile terminal or a network (i.e., a base station or a gateway), duration time of an inactive state during which the mobile terminal does not perform communication, and causing the mobile terminal to make a transition to a sleep mode when the duration time exceeds a predetermined expiration period. Patent literature 1 further discloses measuring, by a mobile terminal or a network (i.e., a base station or a gateway), an occurrence rate of communication of the mobile terminal, and changing a timer value (expiration period) of the timer regarding the sleep mode transition according to the occurrence rate of communication of the mobile terminal. Patent literature 1 further discloses changing the expiration period of the timer regarding the sleep mode transition based on remaining battery power of the mobile terminal.

Patent literature 2 and 3 disclose supplying, from an MCN to a control apparatus (e.g., a base station) in a RAN, a control policy used to control a state transition of a mobile terminal between a CONNECTED state and an IDLE state (hereinafter referred to as “CONNECTED-IDLE transition”). The control policy includes, for example, designation of a time interval (IDLE transition interval) until the time that the mobile terminal makes a transition from the CONNECTED state to the IDLE state. The control policy is managed, for example, by a mobility management node (e.g., a Mobility Management Entity (MME) or a Serving GPRS Support Node (SGSN)) or a subscriber server (e.g., a Home Subscriber Server (HSS)). Patent literature 3 further discloses determining a control policy used to control CONNECTED-IDLE transitions of the mobile terminal according to a situation of the mobile terminal. The situation of the mobile terminal is, for example, an occurrence rate of movement of the mobile terminal, an occurrence rate of communication of the mobile terminal, a time zone to which the mobile terminal belongs, a location where the mobile terminal is positioned, an application program currently activated in the mobile terminal, remaining battery power of the mobile terminal, or a type of a radio access network to which the mobile terminal is currently connected.

The following are definitions of the terms “CONNECTED state” and “IDLE state” used in this specification and Claims. The “IDLE state” means a state in which a mobile terminal does not continuously send or receive control signals for session management and mobility management to or from an MCN, and radio connections in a RAN have been released. An example of the IDLE state is an EPS Connection Management IDLE (ECM-IDLE) state and a Radio Resource Control IDLE (RRC_IDLE) state of the 3GPP. In the RRC_IDLE, an RRC connection, which is a radio connection in the E-UTRAN, is released.

Meanwhile, the “CONNECTED state” means a state in which, as in an ECM-CONNECTED state and an RRC_CONNECTED state of the 3GPP, a radio connection at least for sending and receiving control signals (control messages) for session management and mobility management between the mobile terminal and the MCN is established in a RAN, and such a connection is established as to be able to send and receive control signals (control messages) between the mobile terminal and the MCN. In short, it is only necessary that the “CONNECTED state” is a state in which the mobile terminal is connected to the MCN so as to be able to at least send and receive the control signals (control messages) for the session management and the mobility management. The “CONNECTED state” may be a state in which a data bearer is configured for transmitting and receiving user data between the mobile terminal and an external packet data network (PDN). Alternatively, the “CONNECTED state” may be a state in which the mobile terminal does not have the data bearer though it has the control connection with the MCN. The “CONNECTED state” can also be called an “ACTIVE state”.

Typically, the MCN tracks the location of a CONNECTED state mobile terminal with a cell level granularity, and tracks the location of an IDLE state mobile terminal with a registration area (e.g., a tracking area or a routing area) level granularity. When moved from one location registration area to another location registration area, a mobile terminal which is in the IDLE state sends to the MCN a message indicating an update of the location registration area. Upon arrival of downlink traffic (downlink data or incoming voice call) to the mobile terminal which is in the IDLE state, the MCN sends a paging signal to a paging area defined based on the location registration area.

In this specification, a timer that measures duration time of the inactive state, during which data of a mobile terminal is neither transmitted nor received, to determine a transition of a mobile terminal from the CONNECTED state to the IDLE state is referred to as a “UE inactivity timer” according to the terminology used in the 3GPP.

### CITATION LIST

### Non Patent Literature

[Patent Literature 1] Japanese Unexamined Patent Application Publication No. 11-313370

[Patent Literature 2] International Patent Publication No. WO 2012/093433

[Patent Literature 3] International Patent Publication No. WO 2012/093434

### SUMMARY OF INVENTION

### Technical Problem

As described above, Patent literature 1 to 3 disclose adjusting the expiration period (timer value) of the UE inactivity timer based on the situation of the mobile terminal such as the occurrence rate of movement of the mobile terminal or the occurrence rate of communication of the mobile terminal. The adjustment of the timer value of the UE inactivity timer based on the situation of the mobile terminal is carried out mainly for the purpose of reducing the number of control signals that should be processed by the mobile core network (MCN) and decreasing the load of the MCN. Accordingly, for example, the timer value of the UE inactivity timer is increased as the occurrence rate of communication of the mobile terminal becomes higher.

However, only the adjustment of the timer value of the UE inactivity timer based on the situation of the mobile terminal may cause an increase in the number of mobile terminals that stay in the CONNECTED state. For example, when the total number of CONNECTED state mobile terminals reaches the upper-limit number of the base station or the cell, a new mobile terminal cannot make a transition to the CONNECTED state. That is, a connection success rate of mobile terminals to a network may be lowered.

Accordingly, an object of the present invention is to provide a method, a network node, a base station, and a program that can contribute to suppression of a decrease in a connection success rate of mobile terminals to a network due to adjustments of an expiration period of a UE inactivity timer.

### Solution to Problem

In a first aspect, a method includes determining, based on a congestion degree of a radio access network, an expiration period of a timer used to determine a transition from a CONNECTED state to an IDLE state of a mobile terminal connected through the radio access network to a mobile core network.

In a second aspect, a network node includes a determination unit. The determination unit is configured to determine, based on a congestion degree of a radio access network, an expiration period of a timer used to determine a transition from a CONNECTED state to an IDLE state of a mobile terminal connected through the radio access network to a mobile core network.

In a third aspect, a base station includes a timer and a configuration unit. The timer is used to determine a transition from a CONNECTED state to an IDLE state of a mobile terminal connected to a mobile core network through a radio access network. The configuration unit receives from the mobile core network a message indicating an expiration period of the timer determined based on a congestion degree of the radio access network and configures the expiration period in the timer.

In a fourth aspect, a program includes instructions for causing a computer to perform a control method. The control method includes determining, based on a congestion degree of a radio access network, an expiration period of a timer used to determine a transition from a CONNECTED state to an IDLE state of a mobile terminal connected through the radio access network to a mobile core network.

### Advantageous Effects of Invention

According to the aspects stated above, it is possible to provide a method, a network node, a base station, and a program that can contribute to suppression of a decrease in a connection success rate of mobile terminals to the network due to adjustments of an expiration period of a UE inactivity timer.

### BRIEF DESCRIPTION OF DRAWINGS

FIG. 1 is a block diagram showing a configuration example of a mobile communication system according to a first embodiment;

FIG. 2 is a sequence diagram showing an operation of the mobile communication system according to the first embodiment;

FIG. 3 is a block diagram showing a configuration example of a mobility management node according to the first embodiment;

FIG. 4 is a block diagram showing a configuration example of the mobile communication system according to the first embodiment; and

FIG. 5 is a block diagram showing a configuration example of a base station according to a second embodiment.

### DESCRIPTION OF EMBODIMENTS

Specific embodiments will be explained hereinafter in detail with reference to the drawings. The same symbols are assigned to the same or corresponding elements throughout the drawings, and repetitive explanations will be omitted as necessary.

### First Embodiment

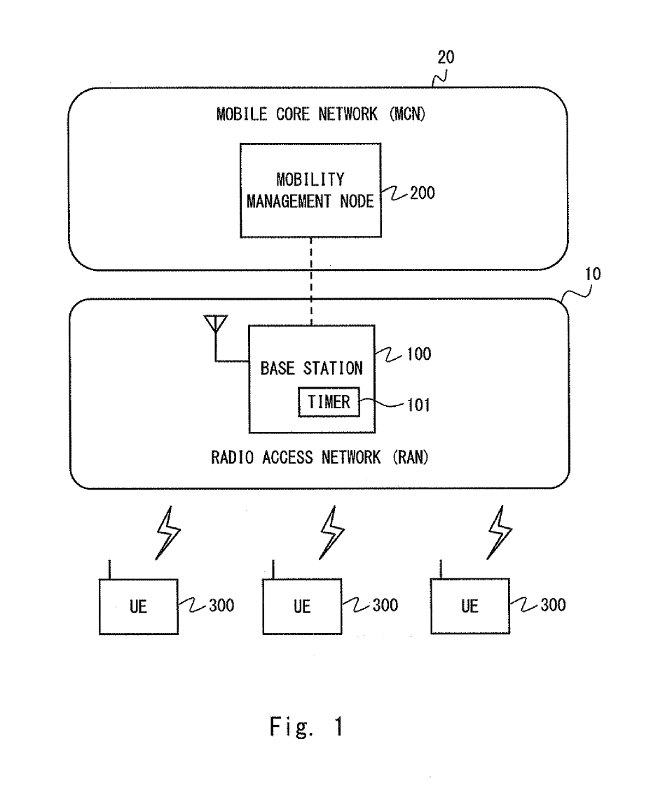

FIG. 1 is a block diagram showing a configuration example of a cellular communication system according to this embodiment. The configuration example shown in FIG. 1 includes a radio access network (RAN) 10 and a mobile core network (MCN) 20. The basic configurations and functions of the RAN 10 and the MCN 20 will be described first.

The RAN 10 includes a base station 100. The base station 100 manages a cell and establishes radio connections (Radio Resource Control (RRC) connections) with mobile terminals 300 by means of a radio access technology. Each mobile terminal 300 having a radio interface is connected to the RAN 10 by means of the radio access technology and is connected to the MCN 20 through the RAN 10. The RAN 10 is, for example, E-UTRAN or UTRAN, or the combination thereof. In the E-UTRAN, the base station 100 corresponds to an E-UTRAN NodeB (eNB). In the UTRAN, the base station 100 corresponds to the functions of a NodeB and a Radio Network Controller (RNC).

In the example shown in FIG. 1, the base station 100 includes a UE inactivity timer 101. The UE inactivity timer 101 is a timer that measures duration time of an inactive state during which user data regarding the mobile terminal 300 is neither transmitted nor received. The UE inactivity timer 101 is started (or restarted) by the base station 100 and is used to determine a change from the CONNECTED state to the IDLE state of the mobile terminal 300. The UE inactivity timer 101 may be arranged in another node arranged in the RAN 10.

The base station 100 starts (or restarts) the UE inactivity timer for the mobile terminal 300 in response to scheduling downlink or uplink radio resources to the mobile terminal 300, for example. Further or alternatively, the base station 100 may start (or restart) the UE inactivity timer for the mobile terminal 300 in response to at least one of reception of downlink data for the mobile terminal 300, transmission of an uplink transmission grant (Uplink Grant) to the mobile terminal 300, transmission of a paging message to the mobile terminal 300, and reception of a radio resource allocation request from the mobile terminal 300.

When the UE inactivity timer 101 expires, the mobile terminal 300 makes a transition from the CONNECTED state to the IDLE state. For example, the base station 100 may request the MCN 20 (more specifically, a mobility management node 200) to release a bearer regarding the mobile terminal 300 in response to expiration of the UE inactivity timer 101, and may release a radio bearer that has been configured for the mobile terminal 300. The mobile terminal 300 may make a transition to the IDLE state in response to release of the radio bearer.

The MCN 20 is a network mainly managed by an operator that provides mobile communication services. The MCN 20 is, for example, an EPC in an Evolved Packet System (EPS), a GPRS packet core in a Universal Mobile Telecommunications System (UMTS), or the combination thereof. The MCN 20 has a control plane function including bearer management and mobility management of the mobile terminal 300 and a user plane function including transfer of user data sent between the mobile terminal 300 and an external PDN. In the example shown in FIG. 1, the MCN 20 includes the mobility management node 200 as a control plane entity. Further, although not shown in the drawings, the MCN 20 includes at least one transfer node as a user plane entity. In the case of the UMTS, for example, the transfer node (not shown) includes a Gateway GPRS Support Node (GGSN) and user plane functions of a Serving GPRS Support Node (SGSN). Further, in the case of the EPS, the transfer node includes a Serving Gateway (S-GW) and a PDN Gateway (P-GW).

The mobility management node 200 performs mobility management and bearer management of the mobile terminal 300 (e.g., bearer establishment, bearer modification, bearer release). For example, in the case of the UMTS, the mobility management node 200 has control plane functions of a SGSN. Further, in the case of the EPS, the mobility management node 200 has a Mobility Management Entity (MME) function. The mobility management node (e.g., MME) 200 is connected to a plurality of base stations (e.g., eNBs) 100 with a control interface (e.g., S1-MME interface), and is connected to the transfer node (e.g., S-GW) with a control interface (e.g., S11 interface). The mobility management node 200 exchanges Non-Access Stratum (NAS) messages that are transmitted between the mobile terminal 300 and the MCN 20. The NAS messages are control messages that are not terminated at the RAN 10 and are transparently transmitted or received between the mobile terminal 300 and the MCN 20 without depending on the radio access technology used in the RAN 10. For example, in response to receiving from the mobile terminal 300 a service request message requesting resource allocation, the mobility management node 200 requests the base station 100 to establish a bearer with the MCN 20 and to establish a radio bearer with the mobile terminal 300.

In the following description, the determination of the expiration period (timer value) of the UE inactivity timer 101 according to this embodiment will be described. In this embodiment, the expiration period (timer value) of the UE inactivity timer 101 is determined based on a congestion degree of the RAN 10. The congestion degree of the RAN 10 may be a congestion degree of one base station 100, a congestion degree of one cell managed by one base station 100, a congestion degree of a plurality of cells managed by one base station 100, or a congestion degree of a plurality of base stations 100 managed by one base station management apparatus (e.g., RNC of UTRAN).

The congestion degree of the RAN 10 is directly or indirectly related to the total number of mobile terminals 300 that are in the CONNECTED state in the base station 100 or in a cell managed by the base station 100. That is, it can be said that the congestion degree of the RAN 10 increases as the total number of mobile terminals 300 that are in the CONNECTED state in the base station 100 or in the cell managed by the base station 100 increases.

The congestion degree of the RAN 10 may be defined using at least one of the parameters shown in the following (1) to (8). For example, the congestion degree of the RAN 10 may be any one of the parameters shown in the following (1) to (8) or may be a value (e.g., a ratio) calculated using any one of the parameters shown in the following (1) to (8). Alternatively, the congestion degree of the RAN 10 may be a statistical value (e.g., a maximum value, a minimum value, an average value, or a median value) regarding any one of the parameters shown in the following (1) to (8):

(1) the total number of mobile terminals 300 that are in the CONNECTED state in the base station 100 or in the cell managed by the base station 100;

(2) the total number of mobile terminals 300 that are in the IDLE state in the base station 100 or in the cell managed by the base station 100;

(3) the total number of mobile terminals 300 that have carried out an inbound handover to the base station 100 or to the cell managed by the base station 100;

(4) the total number of mobile terminals 300 that have carried out an outbound handover from the base station 100 or from the cell managed by the base station 100;

(5) the total number of mobile terminals 300 that are located in the cell managed by the base station 100;

(6) the total number of mobile terminals 300 that have failed to connect to the base station 100 or to the cell managed by the base station 100;

(7) the total number of connection requests from mobile terminals 300 received by the base station 100 or by the cell managed by the base station 100; and

(8) the total amount of communication of mobile terminals 300 in the base station 100 or in the cell managed by the base station 100.

In one example, the base station 100 measures (or calculates) the congestion degree of the RAN 10. In another example, the mobility management node 200, another network node in the RAN 10, or another network node in the MCN 20 may measure (or calculate) the congestion degree of the RAN 10.

In one example, the mobility management node 200 determines the expiration period of the UE inactivity timer 101. In another example, the base station 100, another network node in the RAN 10, or another network node in the MCN 20 may determine the expiration period of the UE inactivity timer 101.

The expiration period of the UE inactivity timer 101 may be determined to become shorter as the congestion degree of the base station 100 (or the congestion degree of the cell managed by the base station 100) increases. For example, the expiration period of the UE inactivity timer 101 is determined to become shorter in a case in which the congestion degree of the base station 100 is a relatively large first value than in a case in which the congestion degree of the RAN 10 is a relatively small second value. That is, the expiration period of the UE inactivity timer 101 becomes short in the base station 100 that is congested since a large number of mobile terminals 300 are performing communication. In contrast, the expiration period of the UE inactivity timer 101 becomes long in the base station 100 where only a small number of mobile terminals 300 are performing communication. Accordingly, in this embodiment, it is possible to mitigate an increase in the total number of mobile terminals 300 that are in the CONNECTED state in the base station 100 (or in the cell managed by the base station 100) and to suppress a decrease in the connection success rate of mobile terminals 300 to the network.

As a matter of course, in addition to the congestion degree of the RAN 10, another parameter may be considered to determine the expiration period of the UE inactivity timer 101. For example, as disclosed in Patent literature 3, a situation of the mobile terminal 300 (e.g., an occurrence rate of movement of the mobile terminal 300, an occurrence rate of communication of the mobile terminal 300, a time zone to which the mobile terminal 300 belongs, a location where the mobile terminal 300 is positioned, an application program currently activated in the mobile terminal 300, remaining battery power of the mobile terminal 300, or a type of a radio access network to which the mobile terminal 300 is currently connected) may also be considered.

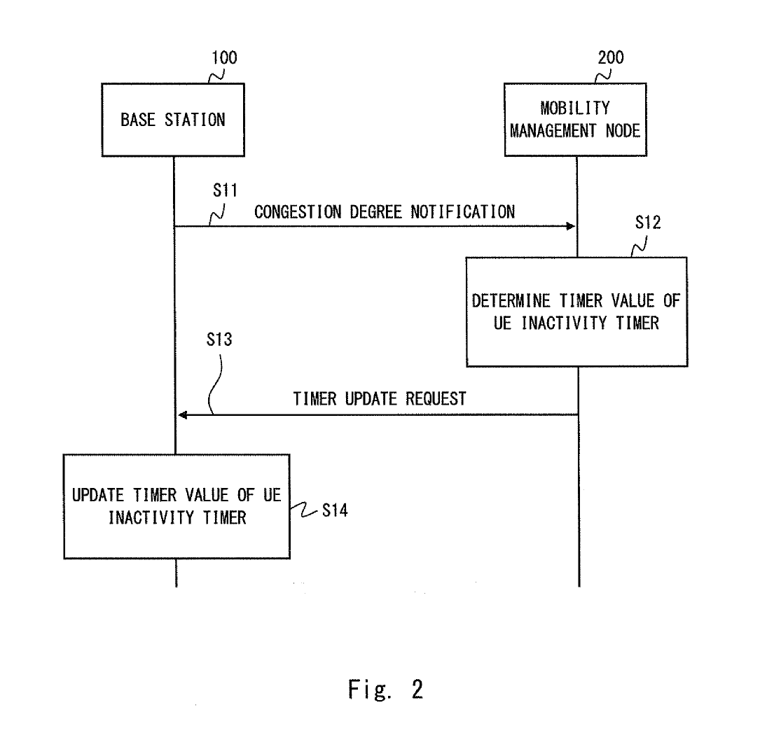

FIG. 2 is a sequence diagram showing one example of the procedure for updating the expiration period of the UE inactivity timer 101 according to this embodiment. In the example shown in FIG. 2, the base station 100 measures (or calculates) the congestion degree of the RAN 10 and the mobility management node 200 determines the expiration period of the UE inactivity timer 101. That is, in Step S11, the base station 100 notifies the mobility management node 200 of the congestion degree of the base station 100 (or the cell managed by the base station 100). The notification of the congestion degree of the base station 100 may be the result of measuring the congestion degree, a notification indicating that the congestion degree of the base station 100 has exceeded a threshold, or a request for updating the UE inactivity timer 101 based on the state in which the congestion degree of the base station 100 has exceeded the threshold.

The notification of the congestion degree of the base station 100 in Step S11 may be sent periodically or aperiodically. The aperiodic notification may be sent, for example, when the congestion degree of the base station 100 has exceeded the threshold. Alternatively, the aperiodic notification may be sent in response to receiving, from the mobile terminal 300, an attach request, a service request (bearer establishment request) or a location update request. In one more alternative, the aperiodic notification may be sent in response to an event regarding the mobile terminal 300 such as an IDLE transition, a disconnection from the network (movement to an out-of-service area), an inbound handover from another cell, or an outbound handover to another cell.

In Step S12, the mobility management node 200 determines the expiration period (timer value) of the UE inactivity timer 101, which is applied to the mobile terminal 300 connected to the base station 100, based on the congestion degree of the base station 100 (or the cell managed by the base station 100). A common expiration period of the UE inactivity timer 101 may be determined for all the mobile terminals 300 connected to the base station 100 or the expiration period may be determined for each mobile terminal 300.

In Step S13, the mobility management node 200 sends the timer value update request indicating the expiration period (timer value) of the UE inactivity timer 101 to the base station 100.

In Step S14, in response to the request from the mobility management node 200, the base station 100 updates the expiration period (timer value) of the UE inactivity timer 101 applied to the mobile terminal 300 connected to the cell managed by the base station 100.

The notification regarding the congestion degree in Step S11 may be sent to the mobile management node 200 from the base station 100 during the existing procedure such as the attach request, the service request, the location update request, or the handover. In a similar way, the timer value update request in Step S13 may be sent to the base station 100 from the mobility management node 200 during the existing procedure such as the attach request, the service request, the location update request, or the handover.

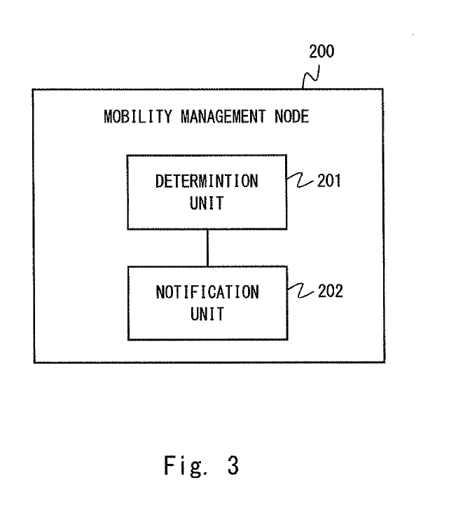

FIG. 3 is a block diagram showing a configuration example of the mobility management node 200 that operates to determine the expiration period (timer value) of the UE inactivity timer 101. The determination unit 201 determines the expiration period of the UE inactivity timer 101 based on at least the congestion degree of the RAN 10. The notification unit 202 communicates with the base station 100 and sends a message indicating the expiration period of the UE inactivity timer 101 to the base station 100.

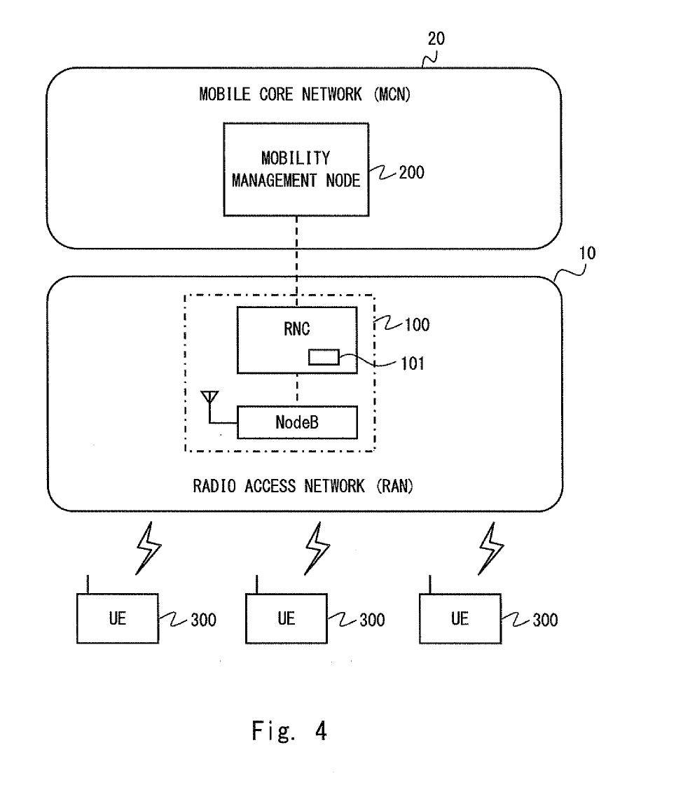

As already stated above, in the case of the UMTS, the base station 100 shown in FIG. 1 includes functions of the RNC and the NodeB. FIG. 4 shows a configuration example of the UMTS network. As shown in FIG. 4, the UE inactivity timer 101 may be arranged in the RNC. The mobility management node 200 shown in FIG. 4 corresponds to control plane functions of the SGSN.

### Second Embodiment

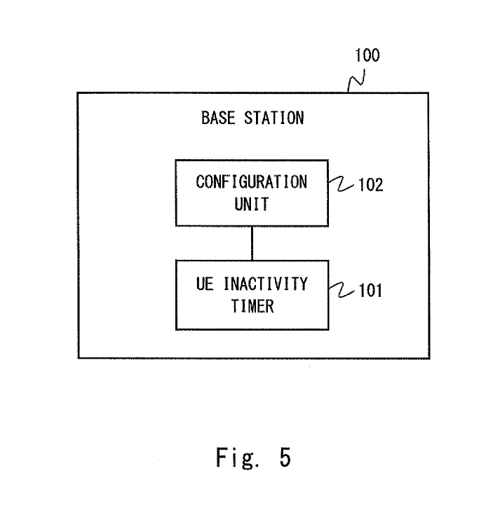

In this embodiment, a modified example of the first embodiment will be described. As already stated above, the determination of the expiration period of the UE inactivity timer 101 may be carried out in a network node within the RAN 10 (e.g., the base station 100), not in the network node within the MCN 20 such as the mobility management node 200. FIG. 5 is a block diagram showing a configuration example of the base station 100 that operates to determine the expiration period (timer value) of the UE inactivity timer 101. The base station 100 shown in FIG. 5 includes a UE inactivity timer 101 and a configuration unit 102. The configuration unit 102 configures the expiration period in the UE inactivity timer 101. Further, the configuration unit 102 shown in FIG. 5 determines the expiration period of the UE inactivity timer 101 based on at least the congestion degree of the base station 100 (or the cell managed by the base station 100).

### Other Embodiments

The first and second embodiments have been described mainly using the specific examples regarding the EPS and the UMTS. However, the first and second embodiments may be applied to other cellular communication systems.

The operations regarding the determination of the expiration period (timer value) of the UE inactivity timer 101 described in the first and second embodiments may be implemented by causing a computer system including at least one processor to execute a program. To be more specific, a computer system may be supplied with one or more programs including instructions to cause the computer system to perform algorithms regarding the determination of the expiration period of the UE inactivity timer 101.

These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Further, the above embodiments are merely examples of applications of technical ideas obtained by the present inventors. Needless to say, these technical ideas are not limited to the above embodiments and various modifications can be made thereto.

This application is based upon and claims the benefit of priority from Japanese Patent Application No. 2013-081925, filed on Apr. 10, 2013, the disclosure of which is incorporated herein in its entirety by reference.

### REFERENCE SIGNS LIST

10 Radio Access Network (RAN)
20 Mobile Core Network (MCN)
100 Base Station
101 UE Inactivity Timer
102 Configuration Unit
200 Mobility Management Node
201 Determination Unit
202 Notification Unit
300 Mobile Terminal

1. A method comprising determining, based on a congestion degree of a radio access network, an expiration period of a timer used to determine a transition from a CONNECTED state to an IDLE state of a mobile terminal connected through the radio access network to a mobile core network.

2. The method according to claim 1, wherein the determining comprises decreasing the expiration period as the congestion degree increases.

3. The method according to claim 1, wherein the congestion degree is related to the total number of mobile terminals that are in the CONNECTED state in a base station within the radio access network or in a cell managed by the base station.

4. The method according to claim 1, wherein the congestion degree is defined using at least one parameter of:
the total number of mobile terminals that are in the CONNECTED state in a base station within the radio access network or in a cell managed by the base station;
the total number of mobile terminals that are in the IDLE state in the base station or in the cell;
the total number of mobile terminals that have carried out an inbound handover to the base station or to the cell;
the total number of mobile terminals that have carried out an outbound handover from the base station or from the cell;
the total number of mobile terminals located in the cell;
the total number of mobile terminals that have failed to connect to the base station or to the cell;
the total number of connection requests from mobile terminals received by the base station or by the cell; and
the total amount of communication of mobile terminals in the base station or in the cell.

5. The method according to claim 1, wherein the determining comprises determining the expiration period by a control node arranged in the mobile core network.

6. The method according to claim 1, further comprising notifying a node, arranged in the radio access network and executing the timer, of the expiration period.

7. The method according to claim 1, wherein the determining comprises determining the expiration period by the base station within the radio access network.

8. The method according to claim 1, wherein the timer measures duration time of an inactive state during which user data regarding the mobile terminal is neither transmitted nor received.

9. The method according to claim 1, wherein the timer is started by a node arranged in the radio access network.

10. A network node comprising at least one hardware processor configured to execute a determination module for determining, based on a congestion degree of a radio access network, an expiration period of a timer used to determine a transition from a CONNECTED state to an IDLE state of a mobile terminal connected through the radio access network to a mobile core network.

11. The network node according to claim 10, wherein the determination module determines the expiration period so that the expiration period becomes shorter as the congestion degree increases.

12. The network node according to claim 10, wherein the congestion degree is related to the total number of mobile terminals that are in the CONNECTED state in a base station within the radio access network or in a cell managed by the base station.

13. The network node according to claim 10, wherein the congestion degree is defined using at least one parameter of:
the total number of mobile terminals that are in the CONNECTED state in a base station within the radio access network or in a cell managed by the base station;
the total number of mobile terminals that are in the IDLE state in the base station or in the cell;
the total number of mobile terminals that have carried out an inbound handover to the base station or to the cell;
the total number of mobile terminals that have carried out an outbound handover from the base station or from the cell;
the total number of mobile terminals located in the cell;
the total number of mobile terminals that have failed to connect to the base station or to the cell;
the total number of connection requests from mobile terminals received by the base station by the cell; and
the total amount of communication of mobile terminals in the base station or in the cell.

14. The network node according to claim 10, wherein the network node is a control node arranged in the mobile core network.

15. The network node according to claim 10, wherein the at least one hardware processor is further configured to execute a notification module for notifying a node, arranged in the radio access network and executing the timer, of the expiration period.

16. The network node according to claim 10, wherein the network node is a base station arranged in the radio access network.

17. The network node according to claim 10, wherein the timer measures duration time of an inactive state during which user data regarding the mobile terminal is neither transmitted nor received.

18. The network node according to claim 10, wherein the timer is started by a node arranged in the radio access network.

19. A base station comprising:
a timer used to determine a transition from a CONNECTED state to an IDLE state of a mobile terminal connected to a mobile core network through a radio access network; and
at least one hardware processor configured to receive from the mobile core network a message indicating an expiration period of the timer determined based on a congestion degree of the radio access network and to configure the expiration period in the timer.

20. The base station according to claim 19, wherein the expiration period is determined to become shorter as the congestion degree increases.

21. The base station according to claim 19, wherein the congestion degree is related to the total number of mobile terminals that are in the CONNECTED state in the base station or in a cell managed by the base station.

22. The base station according to claim 19, wherein the congestion degree is defined using at least one parameter of:
the total number of mobile terminals that are in the CONNECTED state in a base station within the radio access network or in a cell managed by the base station;
the total number of mobile terminals that are in the IDLE state in the base station or in the cell;
the total number of mobile terminals that have carried out an inbound handover to the base station or to the cell;
the total number of mobile terminals that have carried out an outbound handover from the base station or from the cell;
the total number of mobile terminals located in the cell;
the total number of mobile terminals that have failed to connect to the base station or to the cell;
the total number of connection requests from mobile terminals received by the base station or by the cell; and
the total amount of communication of mobile terminals in the base station or in the cell.

23. The base station according to claim 19, wherein the timer measures duration time of an inactive state during which user data regarding the mobile terminal is neither transmitted nor received.

24. A non-transitory computer readable medium storing a program for causing a computer to perform a control method,
wherein the control method comprises determining, based on a congestion degree of a radio access network, an expiration period of a timer used to determine a transition from a CONNECTED state to an IDLE state of a mobile terminal connected through the radio access network to a mobile core network.
